(19) United States
(12) Patent Application Publication
(10) Pub. No.: US 2007/0061625 A1
(43) Pub. Date: Mar. 15, 2007

(54) Automation structure for software verification testing

(76) Inventors: Juan Acosta JR., Austin, TX (US); Jan Elizabeth Hartje, Austin, TX (US); Anil K. Levi, Round Rock, TX (US); Nnaemeka Iriele Emejulu, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/226,959

(22) Filed: Sep. 15, 2005

(51) Int. Cl. G06F 11/00

(52) U.S. Cl. 714/38

(57) ABSTRACT

Functional testing of application software through exercising graphical user interface functions of the application software is automated and enhanced by providing one or more test data sets, one or more classes of panels in which each panel is described according to a set of graphical user interface objects and a set of corresponding methods, and one or more engines which encapsulate one or more test method calls or invocations. During testing and in cooperation with a functional test system, the test data sets are parsed to obtain individual test operations, which are then acting upon by invoking one or more of the engines in order to subject the application program to one or more test conditions. Results are logged, summarized, and optionally emailed to test personnel.

### BACKGROUND OF THE INVENTION

1. Field of the Invention

This invention relates to the automation of testing of application programs from a graphical user interface (“GUI”) perspective.

2. Background of the Invention

Software testing in a general sense is a process used to identify the completeness, correctness, and quality of the a software application, including, but not limited to, its reliability, stability, portability, maintainability, and usability. A set of community standards defined by organizations such as the International Organization for Standardization (“ISO”) provides a baseline reference framework which is used by many organizations for such testing. Other organizations may have internally-developed or proprietary standards and methods for testing, which may be used in place of or supplemental to public standards.

In any software development assignment or project, a number of specialists ranging from project managers to developers are involved during the full project life cycle. As each project component is completed, the written code is generally tested using a predefined set of requirements and use cases to ensure that software functionalities and features are met.

Typically, new application development requires several programmers to create the executable code. Therefore, predefined programming procedures and guidelines are typically established in advance to ensure quality and consistency throughout the project cycle. There are various types of testing available in today's market. However, alpha testing, beta testing, white-box or black-box testing, systems test, and regression test are five types that the industry typically uses.

Alpha testing is usually an in-house test that developers conduct to ensure that the program tested is error-free. This entails using some type of software debugger software to catch any failures in the codes or catch any predefined exceptions as well. Beta testing is typically performed on a pre-release version of the software and is only available to a limited number of general public or end-users. This allows further testing from the user's perspective and enables the software to be released with minimal number of defects. Beta testing is also known as the second stage of the alpha testing.

White-box and black-box testing can be performed through simulated user interfaces or by application programming interfaces, with exposure to source codes or not. In white-box testing, testers have the knowledge of the internal items being tested, and know the test data exactly. It is also known as open-box, clear, structural, or glass box testing. On the other hand, black-box testing, also known as functional test, is a technique where the internal workings of how items are tested is not known to testers; testers will only know the inputs and the expected outputs, but not how the program arrives at the output.

System level testing enables developers to see if there are any communication flaws between various modules. It tests whether or not the proper information is being pass through correctly between components and whether or not the information itself is correct.

Regression testing, also known as verification testing, ensures that new changes made to the current software does not adversely impact the existing software's functionality. This is a type of quality control method to establish that any new changes made to the software program will comply with the underlined rules and guidelines of the existing working program without affecting the program itself.

Because of these frequently used testing methods, some companies have developed suites of tools that facilitate the various types and stages of testing One such suite is the International Business Machines (“IBM”) Rational Functional Tester (“RFT”) [TM]. RFT is an object-oriented automated test tool that allows testing on a variety of different application programs. It encompasses several modules which facilitate in the overall testing procedure. It enables testers to generate or use custom test scripts with choices in scripting languages and development environment. RFT contains object technologies that enables record-and-playback functionality for Java, .Net, and web-based applications. It also provide testers with automation capabilities to perform data-driven testing activities.

For example, when a tester writes or records a test script within RFT, the tools will generate a test object map for the application under test. This object map is similar to a blueprint which contains object properties. It provides flexibility by allowing testers to modify the object map by reusing it, changing it, or by adding more objects as required. Once established, testers can insert verification points into the script which acts to confirm the state of the object across a build process or test process. This is the baseline data file which contains the expected results when the program performs as it should. When a test is completed, a tester can utilize RFT's Verification Point Comparator to analyze differences or update the baseline if the behavior of the object changes.

In addition, Rational Manual Tester [TM] enables manual test authoring and execution tools while Rational TestManager [TM] provides the monitoring for all aspects of manual and automated testing from iteration to iteration. Other tools such as the IBM/Tivoli Identity Manager [TM] (“ITIM”) tool is a web-based application for testing application's which provide security measures to access, such as log in screens. ITIM addresses a need to test the web interface to see how it handles heavy stress and load situations, where manual testing of such user interfaces requires an excessive amount of human data entry and is often impossible to meet the proposed deadline due to time and resource constraints.

Clearly, automation plays a vital role in software testing. With shortened test cycles, reduced resources and increased workloads, testers rely heavily on automation to complete their tasks in timely fashion. With all the variety of testing tools and suites of products available, it is often difficult for testers to implement these tools in an efficient and effective manner.

As business or customer needs change, automation must be updated to reflect changes in the GUI or to include new test cases as functions are introduced. While the overall automation will remain the same, the actual files used will need to be updated over time.

Therefore, because of the various tools available, testers often have to duplicadte testing efforts depending on the testing tools. Each tool may have its own rules and requirements which may not coincide with one another. From manual testing perspective, it can mean more labor and time intensive work even in a partial automated environment.

Thus, there exists a need in the art for a tool to automate and streamline data creation for test cases, test case definition and configuration, and text case execution, for testing application programs through their graphical user interface, and especially for testers utilizing ITIM and RFT.

### SUMMARY OF THE INVENTION

Functional testing of application software through exercising graphical user interface functions of the application software is automated and enhanced by providing one or more test data sets, one or more classes of panels in which each panel is described according to a set of graphical user interface objects and a set of corresponding methods, and one or more engines which encapsulate one or more test method calls or invokations. During testing and in cooperating with a functional test system, the test data sets are parsed to obtain individual test operations, which are then acting upon by invoking one or more of the engines in order to subject the application program to one or more test conditions. Test results are logged, summarized, and optionally emailed to test personnel.

### BRIEF DESCRIPTION OF THE DRAWINGS

The following detailed description when taken in conjunction with the figures presented herein provide a complete disclosure of the invention.

FIG. 1 illustrates the multiple-layer organization of components of the present invention.

FIGS. 2a and 2b show a generalized computing platform architecture, and a generalized organization of software and firmware of such a computing platform architecture.

FIG. 3 depicts how the invention transforms screen objects and methods associated with them into classes for use by the invention.

FIG. 4 sets forth a logical process according to the invention for using the test data and the classes to execute a GUI-driven software application program test.

FIG. 5 illustrates the integration of and cooperation with the invention and a software functional test system or suite.

### DESCRIPTION OF THE INVENTION

The present invention, referred to as Automation Structure for Software Verification Testing using Rational Functional Tester, allows a tester to quickly create a set of data, and then to execute test cases using a suitable GUI automation tool, such as RFT and/or ITIM, to perform structured tests in an orderly and easily updateable fashion. The present invention may alternatively be used with other GUI test automation tools and other SVT tool suites.

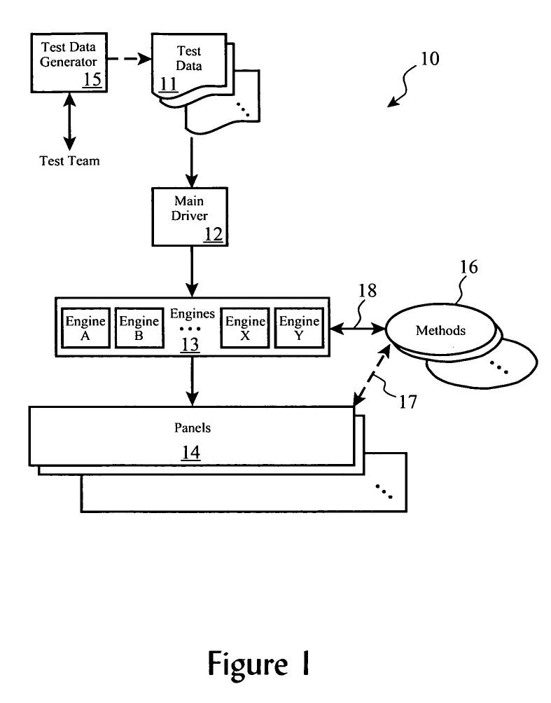

According to one embodiment of the invention, the system (10) comprises four main components as shown in FIG. 1:
(a) panels and methods (14),
(b) engines (13),
(c) a main driver (12), and
(d) test data such as comma separated values (“CSV”) files or alternatively Java multi-dimensional String arrays.

According to another aspect of the present invention, a generator (15) for assisting a test engineer in creating CSV test data is provided.

The engines (13) are controlled by a main driver (12) such that a test team can create an engine (13) for each of the main functions to be used in the testing application. These engines receive the test data files (11) as an input, parse the files, and then call (18) the underlying methods (16) which act (17) upon the GUI panels (14). Preferably, the invention is realized and utilized in conjunction with the IBM RFT and ITIM suites of tools and test environment. Using this approach, the tester simply needs to create the test data files with configuration options for the desired test cases, provide or re-use appropriate engines for each function of the application program to be tested, and then run the main driver using CSV inputs. This eliminates hours of manual labor and perform testing in a more streamline way.

Panels and Methods

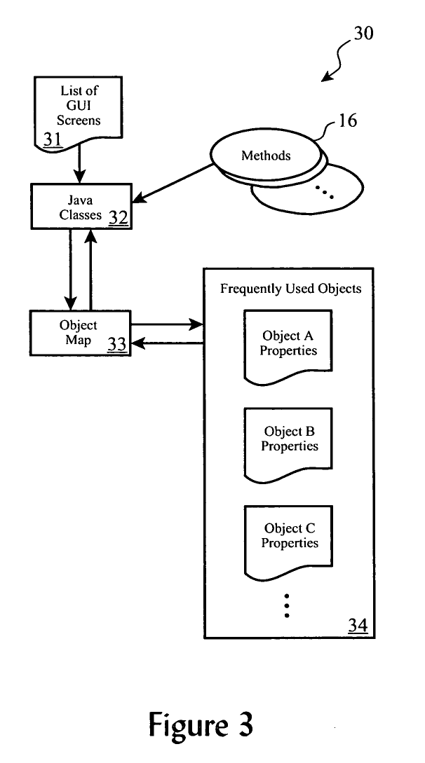

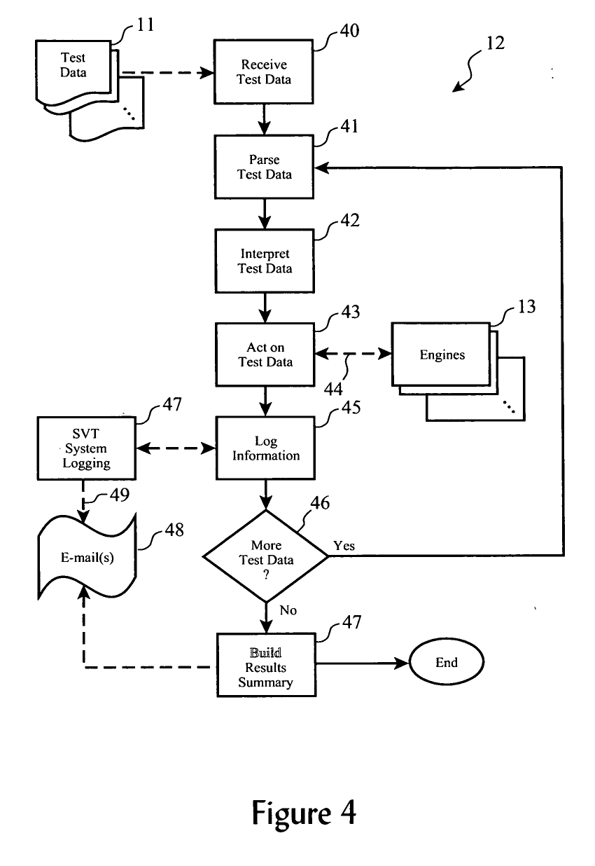

The actual recording of objects in the ITIM GUI is based on a panel and method model. Turning to FIG. 3, an illustration (30) of how program objects are recorded according to invention is shown. First, preferably using the RFT or alternatively an equivalent functional tester system, a list of distinct GUI screens (31) is used to create an object-oriented programming (“OOP”) class (32) for every distinct screen in the GUI. The OOP classes are preferably, but not necessarily, compatible with Sun Microsystems' [TM] Java [TM] programming language and methodology.

Each of these classes are referred to as a panel. A panel has its own object map (33) which contains only the objects found on that screen of the GUI, such as images, drop-down lists, buttons, check boxes, radio buttons, text portions, etc. The object map is populated with the objects (34) of the panel by recording the object and its properties into the map, preferably using capabilities of the RFT suite.

Further, methods (16) which act upon the objects in the object map (33) are then added to the classes (32). For example, if a panel has a Submit button on it, the information about the button (e.g. graphical image used, location, etc.) will be stored in the object map and the class would be updated to include the method invoked when the button is operated by a user, such as a clickSubmit( ) method.

This approach compartmentalizes the GUI in a manner where each and every object belonging to a corresponding class, which includes the methods which are invoked by or upon those objects.

Engines

Another layer of one embodiment of the invention is the engines layer. While the panel and method structure gives the tester access to each object and the corresponding methods in each GUI, our research found that testers often use the same series of method calls repeatedly. So, according to another aspect of the present invention, these repetitively used series of method calls are abstracted into “engines” (13), which eliminates redundant coding efforts. The engines work by calling the panels and methods that pertain to the desired activity. Thus, they allow the tester to navigate through the GUI by simply calling the desired engine and not having to repeat method calls.

To accomplish this in one manner according to the invention, the invention provides a pre-compiled list of main areas of the GUI test suites', such as ITIM's, functionality. Also, based on such a list of main activities a typical tester will use in these functional areas, these series of method calls are extracted into corresponding engines.

For example, a Person Engine provides testers the ability to add, delete, transfer, suspend and modify users via the specific panels or screens normally used by users to do the same functions (e.g. screens normally accessed by system administrators).

The Engines take a test data, and preferably CSV data, as an input. The test data file tells the engine which actions to perform and with what values. If the tester wants run a test in which a user is “deleted”, the tester will configure the test data to call the Person Engine with a CSV containing the reserve word “delete” followed by the username of the person the tester wishes to delete, as shown in Table 1.

TABLE 1
Example CSV Test Data

. . .
delete John_Smith_123
. . .

In this manner, a tester can quickly generate test cases and does not have to take the time to compile the multiple method calls from the various panels required to delete the person. The engines were written to support the most common activities a tester would need to perform in the GUI. These can be expanded at any time, however, to include more functionality as the product evolves. Likewise, testers may also create their own engines to encapsulate series of method calls which they use repetitively, as well as utilize the engines provided by the invention.

In one embodiment of the invention, which focused on testing system administrator (“sys-admin”) tools, a plurality of engines for common sys-admin functions was provided, such as user account management functions (e.g. add, modify delete users, their addresses, telephone numbers, etc.), policy management functions (e.g. add, modify, delete, apply, remove identity policies, permissions, etc.), and services (e.g. add, modify, delete system services such as backup, restore, subaccount rights, etc.).

Main Driver

According to another aspect of the present invention, the main driver (12) provides an abstraction layer between the engines (13) and the test data (12) in order to allow a test engineer or team to keep from having to remember all engine names, and to have the ability to invoke the different engines from the same test Java Test Code and/or test datapool (11). The main driver also abstracts the logging and emailing functions of the system.

As development progresses, an application developer can modify or update “engine” code without impacting the test case design (e.g. the test engineer will not necessarily have to make corresponding updates to the test cases and test data).

Basic Flow

The Main Driver (12) accepts (40) as input one or more test data files (11), such as CSV files or Java multi-dimensional String arrays. These inputs are parsed (41), preferably one line at a time and are interpreted (42), followed by acting (43) upon them accordingly, such as by invoking (44) one or more engines (13) with control parameters and data. The Main Driver acts on these individual inputs and either customizes the test run, or sets up some particular environment before the test or send the input to a specific Engine to be consumed.

Logging

The Main Driver performs information logging (45), preferably specific to ITIM, with the SVT system (47) with which it cooperates. For example, in the preferred embodiment, it instantiates the SvtLogger and uses Rational XDE Java APIs to log calls to the logger. Any Engine can make a call to the logger in the driver and access the logging features. The test engineer will not have to wade through XDE logs to look for ITIM specific information by using this aspect of the invention.

Emailing

After the Main Driver exhausts all inputs (CSV's or Arrays) (46), it preferably builds (47) a summary of the run statistics, and emails (48) this information to all the testers configured to receive this email. It also preferably attaches (49) the ITIM specific log file that the Main Driver created.

Summary of Main Driver

In summation, the Main Driver brings together all the code modules together and abstracts the “Java Code” from the tester who writes testcases. The tester at this junction will build his entire test flow and logic (as plain text strings) inside CSV files save them as datapools, include the datapool names in the Main Driver call and go home. The tester will receive an email with summary and detailed information in the attached log.

Test Manager Integration

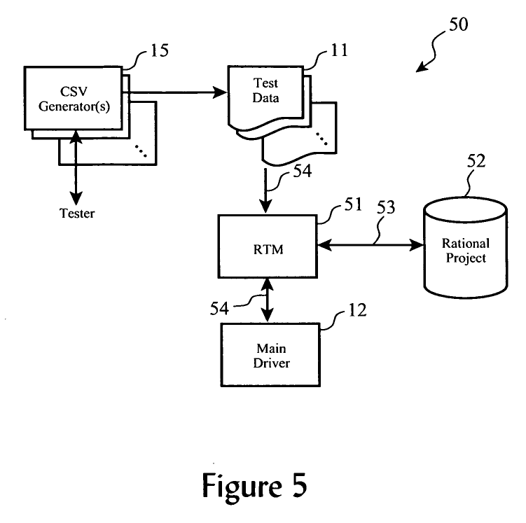

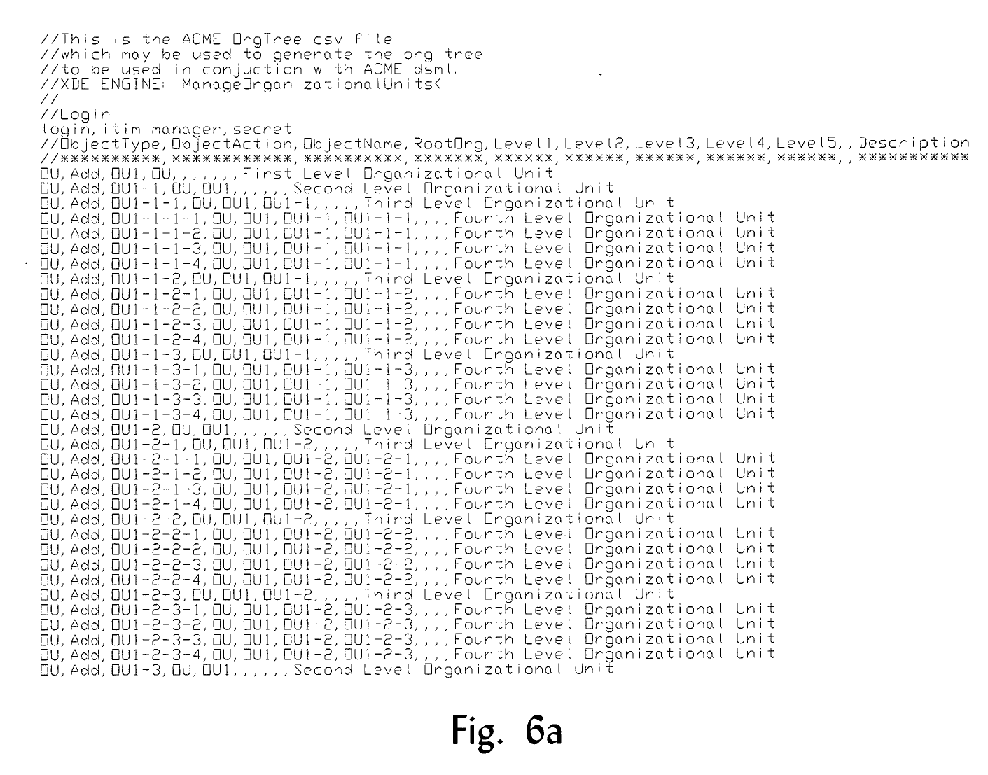

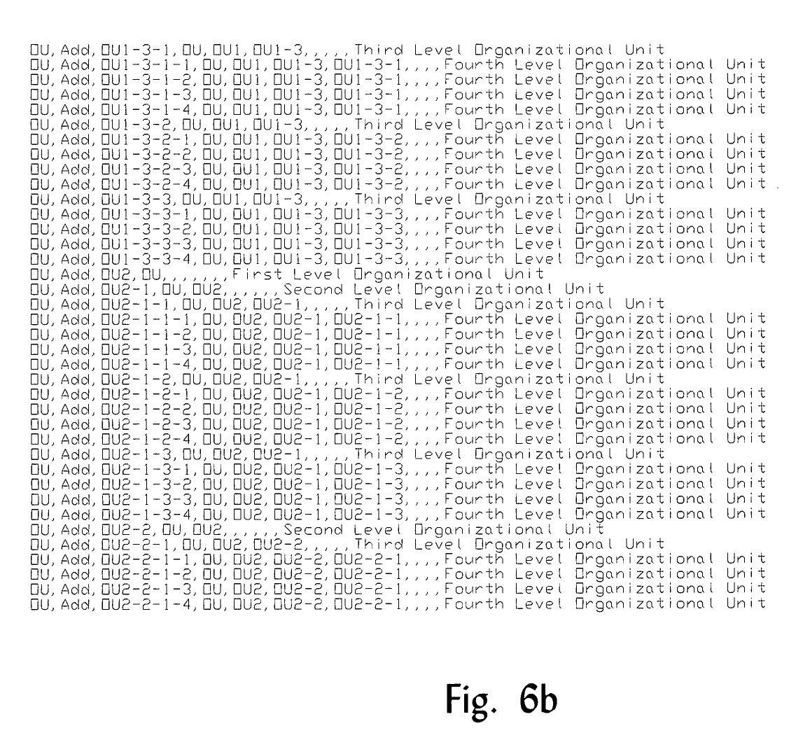

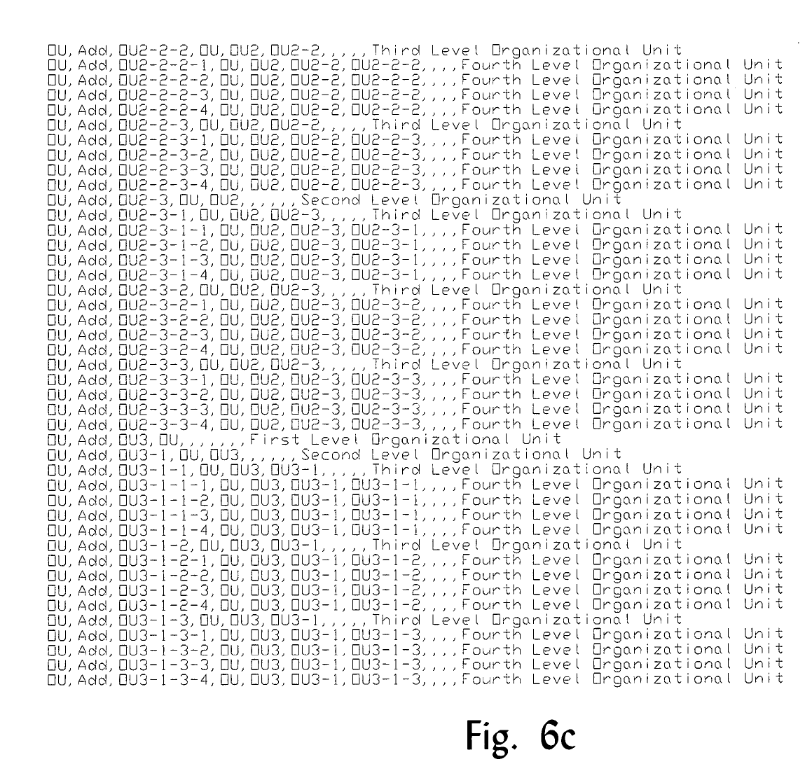

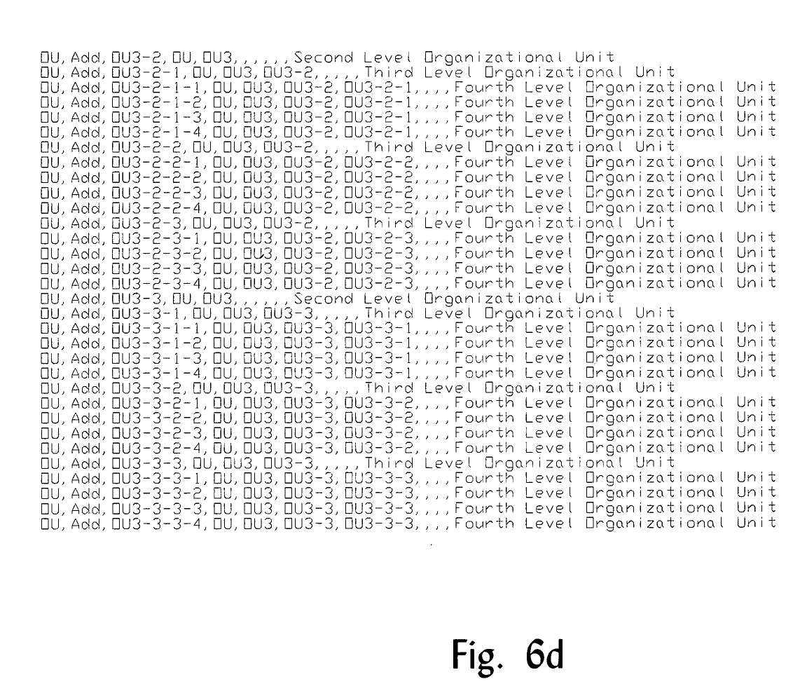

The present invention preferably uses Rational TestManager [TM] (51) as the bridge between the Main Driver (12) and input test data files (15), as shown (50) in FIG. 5. SVT testing utilizes massive amounts of data and entering them manually isn't a viable or practical time investment.

By creating flat data files (11) using the CSV generators (15), the needed data is supplied to the TestManager (51), which in turn gives the data to the Main Driver (12) in an easy and efficient manner.

Once the input test data is created, it is imported (54) into TestManager and becomes a test asset of the Rational project (52). When the Main Driver (12) specifies which test data file (11) it needs to use, Functional Tester accesses the datafiles associated (53) with the project (52), finds the test data file, and then allows the Main Driver to read (54) the data.

CSV File Generation

According to another aspect of the present invention, a new system was created that reads variable information from comma separated value (CSV) files in order to efficiently develop and execute automated GUI test cases. The files can be created using Rational TestManager, Microsoft Excel [TM], or simple text editors like TextPad or Notepad. In order to save the end-user time and energy, the ITIM automation team developed easy to use CSV generators. These CSV generators are written in stark contrast to the complexity of the Java based Engine/Main Driver system.

The CSV generators (15), developed in one embodiment of the invention using Perl V5.6.1, are simple scripts that follow a basic question/response format. In this particular embodiment of the invention, all of the CSV generators are bundled into an archive file, such as a PkZIP or WinZip file.

After unpacking or extracting the generators from this file, a new directory is preferably created that contains the various CSV generators. Preferably a top-level script is provide which, when executed, calls all the other CSV generators via a set of question and answer subroutines.

According to another aspect of the present invention, the Engines in this new system pass object variable data to the Main Driver. This data can be in the form of arguments from the Java class file, or in the CSV format. Table 2 shows an example of data to create and Organization Unit in CSV format.

TABLE 2
Example CSV Test Data

. . .
OU,add,OU1-1,ACME,OU1 . . .
. . .

In Table 2, the first entry is the Engine Keyword, the next entry is the Action to be performed, the next entry is the name of the Organization Unit to be created. The CSV generators generally all follow the same process:
(a) start query of the tester;
(b) compile test data; and
(c) end query.

FIGS. 6a-6d illustrate a more complete CSV test data file example in which a hypothetical organization tree for company “ACME” is created.

Suitable Computing Platform

The invention is preferably realized as a feature or addition to the software already found present on well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

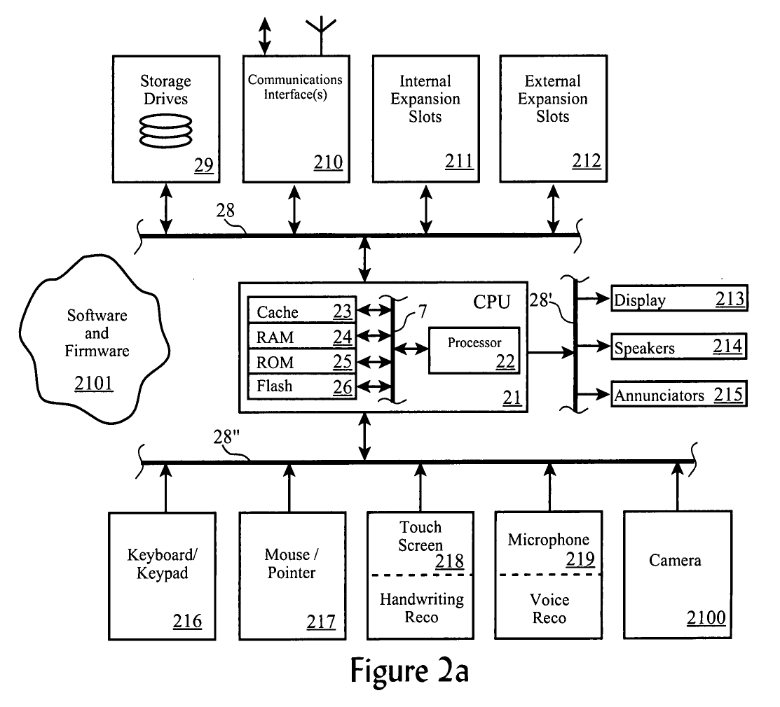

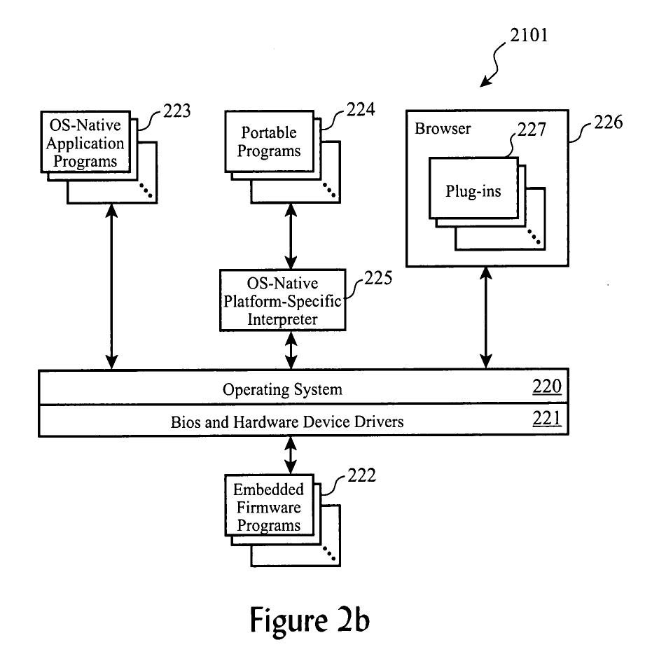

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as a hard-disk drives (“HDD”), floppy disk drives, compact disc drives (CD, CD-R, CD-RW, DVD, DVD-R, etc.), and proprietary disk and tape drives (e.g., lomega Zip [TM] and Jaz [TM], Addonics SuperDisk [TM], etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java [TM] scripts and programs.

Often, computing platforms are also provided with a form of web browser or micro-browser (226), which may also include one or more extensions to the browser such as browser plug-ins (227).

The computing device is often provided with an operating system (220), such as Microsoft Windows [TM], UNIX, IBM OS/2 [TM], IBM AIX [TM], open source LINUX, Apple's MAC OS [TM], or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV [TM] units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

Conclusion

The present invention has been described in conjunction with several illustrative example embodiments. It will be recognized by those skilled in the art, however, that the scope of the invention is not limited to this examples, and that certain alternate embodiments may be realized, such as use of alternate programming languages, methodologies, computing platforms, and integration to alternate test suites and programs, without departing from the spirit and scope of the invention. For these reasons, the scope of the invention should be determined by the following claims.

What is claimed is:

1. A method for automating functional testing of software comprising the steps of:
providing one or more test data sets, one or more classes of panels in which each panel is described according to a set of graphical user interface objects and a set of corresponding methods, and one or more engines which encapsulate one or more test method calls or invokations;
parsing said test data sets by a main driver to obtain individual test operations;
acting upon said individual test operations by invoking one or more of said engines in cooperation with a software functional test system such that an application program is subjected to one or more test conditions;
cooperative with said software functional test system, receiving one or more results of said test conditions; and
producing a human-readable log of said results.

2. The method as set forth in claim 1 wherein said step of providing test data sets comprises providing a script which implements a user question and user response format, wherein said script produces a test data file responsive to user responses.

3. The method as set forth in claim 2 wherein said step of producing a test data file comprises producing a comma separated variables format file.

4. The method as set forth in claim 2 wherein said step of producing a test data file comprises producing one or more Java multi-dimensional String arrays.

5. The method as set forth in claim 1 wherein said step of parsing is performed on a line-by-line basis.

6. The method as set forth in claim 1 wherein said step of one or more classes of panels further comprises compartmentalizing a graphical user interface of said application program such that each and every object used in each screen belong to a corresponding class, and each class includes one or more methods which are invoked by or upon objects within each class, wherein each class represents a panel.

7. The method as set forth in claim 6 further comprising:
creating an object map for each panel;
populated each object map with object properties of objects utilized within a graphical user interface screen associated with each panel; and
adding methods to each class which are invoked by said objects or act upon said objects according to said object map.

8. The method as set forth in claim 1 further comprising the steps of:
summarizing said results; and
sending said summarized results to one or more test personnel using an electronic messaging system.

9. A computer-readable medium encoded with computer-executable code for automating functional testing of software, said computer-executable code performing the steps of:
providing one or more test data sets, one or more classes of panels in which each panel is described according to a set of graphical user interface objects and a set of corresponding methods, and one or more engines which encapsulate one or more test method calls or invokations;
parsing said test data sets by a main driver to obtain individual test operations;
acting upon said individual test operations by invoking one or more of said engines in cooperation with a software functional test system such that an application program is subjected to one or more test conditions;
cooperative with said software functional test system, receiving one or more results of said test conditions; and
producing a human-readable log of said results.

10. The computer-readable medium as set forth in claim 9 wherein said code for providing test data sets comprises a script which implements a user question and user response format, wherein said script produces a test data file responsive to user responses.

11. The computer-readable medium as set forth in claim 10 wherein said code for producing a test data file comprises code for producing a comma separated variables format file.

12. The computer-readable medium as set forth in claim 10 wherein said code for producing a test data file comprises code for producing one or more Java multi-dimensional String arrays.

13. The computer-readable medium as set forth in claim 9 wherein said code for parsing is performed on a line-by-line basis.

14. The computer-readable medium as set forth in claim 9 wherein said code for providing one or more classes of panels further comprises code for compartmentalizing a graphical user interface of said application program such that each and every object used in each screen belong to a corresponding class, and each class includes one or more methods which are invoked by or upon objects within each class, wherein each class represents a panel.

15. The computer-readable medium as set forth in claim 14 further comprising code for:
creating an object map for each panel;
populated each object map with object properties of objects utilized within a graphical user interface screen associated with each panel; and
adding methods to each class which are invoked by said objects or act upon said objects according to said object map.

16. The computer-readable medium as set forth in claim 9 further comprising code for:
summarizing said results; and
sending said summarized results to one or more test personnel using an electronic messaging system.

17. A system for automating functional testing of software comprising:
one or more test data sets;
one or more classes of panels in which each panel is described according to a set of graphical user interface objects and a set of corresponding methods;
one or more engines which encapsulate one or more test method calls or invokations;
a main driver adapted to parse said test data sets to obtain individual test operations, and to act upon said individual test operations by invoking one or more of said engines in cooperation with a software functional test system such that an application program is subjected to one or more test conditions; and
a logger adapted to, cooperative with said software functional test system, receive one or more results of said test conditions, and to produce a human-readable log of said results.

18. The system as set forth in claim 17 wherein said test data sets comprise one or more Java multi-dimensional String arrays.

19. The system as set forth in claim 17 wherein said classes of panels further comprise one or more compartmentalized a graphical user interfaces of said application program in which each and every object used in each screen belongs to a corresponding class, and each class includes one or more methods which are invoked by or upon objects within each class, wherein each class represents a panel.

20. The system as set forth in claim 17 further comprising:
an object map created for each said panel, and populated with object properties of objects utilized within a graphical user interface screen associated with each panel; and
method added to each class which are invoked by said objects or act upon said objects according to said object map.
